(19) United States
(12) Patent Application Publication
(10) Pub. No.: US 2013/0253850 A1
(43) Pub. Date: Sep. 26, 2013

(54) HEALTH MONITORING METHOD AND SYSTEM FOR DRIVES

(71) Applicant: Antti Sakari AULANKO, Helsinki (FI)

(72) Inventor: Antti Sakari AULANKO, Helsinki (FI)

(73) Assignee: ABB Oy, Helsinki (FI)

(21) Appl. No.: 13/622,846

(22) Filed: Sep. 19, 2012

Related U.S. Application Data
(63) Continuation of application No. PCT/FI2011/050239, filed on Mar. 21, 2011.
(60) Provisional application No. 61/315,555, filed on Mar. 19, 2010.

(51) Int. Cl. G01N 29/46

(52) U.S. Cl. CPC G01N 29/46
USPC 702/33

(57) ABSTRACT

In an exemplary method for condition monitoring of electric and mechanical drives, measurement data in a condition monitoring system of electric drives is collected at least from one electric drive. The measurement data is pre-treated, a frequency spectrum is created from the pre-treated measurement data with the Fast Fourier Transform transformation, and a detected vibration frequency and vibration amplitude are recorded from the frequency spectrum. The detected vibration frequency and vibration amplitude is compared to at least one detected vibration frequency and vibration amplitude successive in time. In the comparison, detrimental changes in vibration frequency and vibration amplitude are defined, and the detrimental changes are indicated.

### RELATED APPLICATION

This application is a continuation application under 35 U.S.C. §120 of PCT/FI2011/050239 filed as an International Application on Mar. 21, 2011 designating the U.S., which claims the benefit under 35 U.S.C. §119 of U.S. Provisional Patent No. 61/315,555 filed on Mar. 19, 2010, the entire contents of which are hereby incorporated by reference in their entireties.

### FIELD

A method and a system are disclosed for monitoring a condition of electric and mechanical drives.

### BACKGROUND INFORMATION

The demands of condition monitoring systems have increased because the complexity of paper and cardboard production machines, instrumentation and control systems has increased and downtimes have become shorter.

Intelligent diagnostics include preventive condition monitoring and intelligent monitoring. Preventive condition monitoring is based on prognostics, (e.g., the anticipation of future incidents, and diagnostics, and a conclusion on the condition of the machine). Intelligent monitoring tries to communicate the information of preventive condition monitoring to the operators as efficiently and adaptively as possible.

There are very many rotational movements in paper and cardboard machines driven by motor drives. Roller systems include motors, gears, power transmission shafts, switches and wires. Due to the rotational movements, there can be a substantial amount of vibration in paper machines. Certain vibrations occur in the normal states of the process (e.g., they are a part of normal process operations). However, changes in the frequencies and amplitudes of the normal states and the occurrence of new frequencies may be caused by malfunctions.

Torsional vibration is created by the flexibility of power transmission shafts. The occurrence of detrimental torsional vibration may be a long process, since mechanics are wearing out, inertia masses are changing or the adjustments of an electric drive are changing. The used running speed may also differ from the one used in the original tuning and stabilization, in which case the running speed may strengthen the torsional vibration of the power transmission shaft. In this case, torsional vibration may be detrimental to mechanics and the paper and cardboard production process.

Current offline solutions are performed manually and they do not enable constant monitoring of vibration. In this case, when the system changes and the vibration starts, it will not be noticed early enough and mechanical damage will occur.

There are devices on the market to measure constant vibration, mainly for finding damage in bearings, etc. The monitoring of torsion vibration involves separate sensors, connections, programs and interpretation of the results.

The installation of separate vibration measurement devices to all power transmission systems of electric drives can be very labor-intensive and expensive.

### SUMMARY

A method is disclosed for condition monitoring of electric and mechanical drives, comprising: collecting measurement data in a condition monitoring system of electric drives at least from one electric drive; pre-treating the measurement data and forming a frequency spectrum with a Fast Fourier Transform transformation from the pre-treated measurement data; recording detected vibration frequency and vibration amplitude from the frequency spectrum; comparing the detected vibration frequency and the vibration amplitude to at least one detected vibration frequency and vibration amplitude successive in time; defining detrimental changes in the vibration frequency and vibration amplitude in the comparing; and indicating detrimental changes.

A condition monitoring system is also disclosed for electric and mechanical drives, which system comprises: means for collecting measurement data from at least one electric drive; means for pre-treating measurement data; means for forming a frequency spectrum from pre-treated measurement data with a Fast Fourier Transform transformation; means for saving a vibration frequency and a vibration amplitude detected from the frequency spectrum; means for comparing the detected vibration frequency and vibration amplitude to at least one detected vibration frequency and vibration amplitude successive in time; means for defining in the comparing means detrimental changes in a vibration frequency and a vibration amplitude; and means for indicating detrimental changes.

### BRIEF DESCRIPTION OF THE DRAWINGS

In the following, the invention will be described in more detail with the help of certain embodiments by referring to the enclosed drawings, where:

FIG. 1 illustrates an exemplary condition monitoring system.

### DETAILED DESCRIPTION

A method and a system are disclosed for monitoring the condition of electrical and mechanical drives.

In an exemplary method for controlling the condition of electric and mechanical drives, the measurement data in the condition monitoring system of electric drives is collected from at least one electric drive. The measurement data is pre-treated, a frequency spectrum is created from the pre-treated measurement data with the Fast Fourier Transform transformation, and the detected vibration frequency and vibration amplitude are recorded from the frequency spectrum. The detected vibration frequency and vibration amplitude is compared to at least one detected vibration frequency and vibration amplitude successive in time. In the comparison, detrimental changes in vibration frequency and vibration amplitude are defined, and detrimental changes are indicated.

The condition monitoring system for electric and mechanical drives comprises means to collect measurement data from at least one electric drive, means to pre-treat measurement data, means to form a frequency spectrum from pre-treated measurement data with the Fast Fourier Transform transformation, means to save the vibration frequency and the vibration amplitude detected from the frequency spectrum, means to compare the detected vibration frequency and vibration amplitude to at least one detected vibration frequency and vibration amplitude successive in time, means to define in the comparison detrimental changes in the vibration frequency and the vibration amplitude, and means to indicate detrimental changes.

According to an exemplary embodiment, measurement data is pre-treated with a window function.

According to second exemplary embodiment, the used window function is the Hann window function.

According to another exemplary embodiment, detrimental changes are indicated to the control system of electric drives.

According to yet another exemplary embodiment, the measured data is the speed of motor.

Exemplary embodiments as disclosed herein can make it possible to monitor and detect torsional vibration in the power transmission of an electric drive. This helps to avoid mechanical damage, since the vibration may be detected and corrected early enough.

The detrimental vibration of power transmission shaft can be detected immediately after it starts to occur. In this case, it is possible to start desired actions before the vibration increases and damage is caused. New separate vibration measurement devices are not required, because condition monitoring is performed with the information collected by the data collecting system of electric drives.

According to an exemplary embodiment, the condition monitoring system of vibration in the power transmission shaft is connected to controls so that adjustments are corrected automatically when detrimental vibration occurs. In this case, the detection, monitoring and filtering of vibration in the power transmission shaft is done independently and adaptively.

In an exemplary embodiment, the method can be implemented using a computer.

An exemplary condition monitoring system is disclosed for a roller drive's power transmission shaft in a paper or cardboard machine through the data collection of electric drives. The method is used to detect the characteristic vibration frequency of the roller drive's power transmission shaft. The changes in the characteristic vibration frequency of the power transmission shaft, the changes in the effective value (e.g., amplitude) and in the peak-to-peak value of this characteristic vibration, are observed in the method.

The power transmission from the electric motor to the roll is realized with gear components including, for example, shafts, gears and switches. Power transmission shafts are planned so that their characteristic vibration frequencies are outside the roll rotation frequencies.

The electric drive transforms electric energy to motion energy with the electric motor.

The condition monitoring system of the power transmission shaft between the electric motor and paper machine's roll can measure and perform an analysis regularly—for example, once a day for each drive.

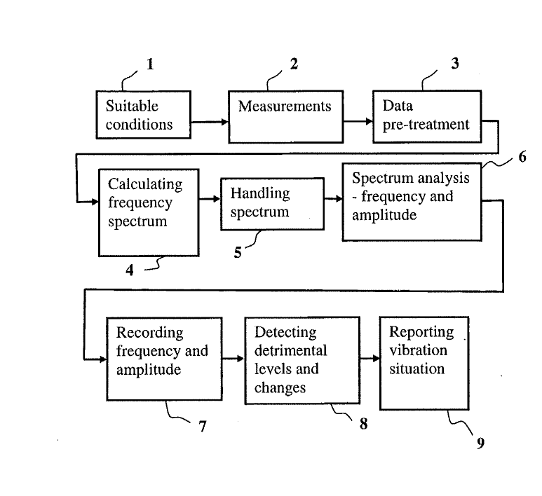

FIG. 1 illustrates a condition monitoring system. The measurements can be performed regularly and in conditions similar to each other (Phase 1).

The analysis includes first the measurements (e.g., the collection of information (Phase 2)). With rotating machines, there are many signals including periodic or rotational components. In this case, analysis of the frequency level is suitable for the condition monitoring of mechanical and electric components. The data collection system of electric drives collects measurement data from speed, for example.

The electric drive's measurement quantity suitable for analyzing the whole frequency range is the speed of the motor.

After this, windowing is performed as the pre-treatment of collected measurement data (Phase 3). The Hann function is used for windowing to make the samples continuous in time. Other possible windowing functions are, for example, the Blackmann function and the Hamming function.

After windowing, the frequency spectrums of one or more successive measurements will be calculated with the help of Fast Fourier Transform (FTT, Phase 4). The amplitudes of certain frequencies are clarified from the signal with the help of the Fourier analysis.

The frequency spectrum to be analyzed is the average of these frequency spectrums (Phase 5). To make the analysis as independent from the roll system and its power transmission system, the surface area of the obtained frequency spectrum is scaled to a constant.

After this, the spectrum to be analyzed is analyzed with algorithm (Phase 6). The algorithm helps to detect frequency peaks from the spectrum. In the analysis, all frequency components exceeding the amplitude limit which defines the amplitude limit of detrimental vibration are put in an order based on the size of amplitude.

The frequency, amplitude and time-level's peak-to-peak parameter are recorded for the detected frequency component for monitoring purposes (Phase 7). The peak-to-peak parameter is the difference of the largest and smallest value of the signal. The peak-to-peak parameter is calculated for the speed's actual value. It describes the intensity of the vibration in the signal. These quantities can be monitored in a two-dimensional view.

Thus, these frequency components calculated from the frequency spectrum are seen as detrimental (Phase 8). The vibration situation is reported (Phase 9). The condition monitoring system informs the control room or other further handling when detrimental vibration is detected.

As a result of increased characteristic vibration, the power transmission shaft may get damaged. Therefore, vibration should be damped, for example, by changing mechanics, adjusting the speed regulator or by damping vibration through programming.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for condition monitoring of electric and mechanical drives, comprising:
collecting measurement data in a condition monitoring system of electric drives at least from one electric drive;
pre-treating the measurement data and forming a frequency spectrum with a Fast Fourier Transform transformation from the pre-treated measurement data;
recording detected vibration frequency and vibration amplitude from the frequency spectrum;
comparing the detected vibration frequency and the vibration amplitude to at least one detected vibration frequency and vibration amplitude successive in time;
defining detrimental changes in the vibration frequency and vibration amplitude in the comparing; and
indicating detrimental changes.

2. A method according to claim 1, comprising:
pre-treating the measurement data with a window function.

3. A method according to claim 2, wherein the window function is the Hann window function.

4. A method according to claim 1, wherein the detrimental changes are indicated to a control system of the electric drives.

5. A method according to claim 1, wherein the measurement data is a speed of a motor.

6. A condition monitoring system for electric and mechanical drives, which system comprises:
means for collecting measurement data from at least one electric drive;
means for pre-treating measurement data;
means for forming a frequency spectrum from pre-treated measurement data with a Fast Fourier Transform transformation;
means for saving a vibration frequency and a vibration amplitude detected from the frequency spectrum;
means for comparing the detected vibration frequency and vibration amplitude to at least one detected vibration frequency and vibration amplitude successive in time;
means for defining in the comparing means detrimental changes in a vibration frequency and a vibration amplitude; and
means for indicating detrimental changes.

7. A condition monitoring system according to claim 6, comprising:
a control system in combination with the condition monitoring system for receiving an indication of detrimental changes form the indicating means.
